(19) United States
(12) Patent Application Publication
(10) Pub. No.: US 2016/0065837 A1
(43) Pub. Date: Mar. 3, 2016

(54) WIRELESS ADAPTOR FOR DISPLAY DEVICE

(71) Applicant: ESSEL-T CO., LTD., Seongnam-si (KR)

(72) Inventor: Shin Ho KIM, Seongnam-si (KR)

(73) Assignee: ESSEL-T CO., LTD., Seongnam-si (KR)

(21) Appl. No.: 14/497,841

(22) Filed: Sep. 26, 2014

(30) Foreign Application Priority Data
Sep. 3, 2014 (KR) 10-2014-0117170

(51) Int. Cl. H04N 5/232

(52) U.S. Cl. CPC H04N 5/23216; H04N 5/23209

(57) ABSTRACT

A wireless adaptor for operating a display device that is detachably installed in a camera with a wireless communication function and mounted on the wireless adaptor is provided. The wireless adaptor includes a main body, a wireless communication module, a controller, and a battery. The main body includes: an accommodation area in which the display device is situated; and a connector formed on one side of the accommodation area to be electrically connected with the display device. The wireless communication module is mounted within the main body to perform wireless communication with the camera. The controller is mounted within the main body and includes a display operating part to receive image data captured and transmitted from the camera through the wireless communication module and outputs the received image data to the display device. The battery is mounted within the main body to supply power to the controller.

### CROSS-REFERENCE TO RELATED APPLICATION(S)

This application claims priority from Korean Patent Application No. 10-2014-0117170, filed on Sep. 3, 2014, in the Korean Intellectual Property Office, the disclosure of which is incorporated herein by reference in its entirety.

### BACKGROUND

1. Field

The following description relates to a wireless adaptor for operating a display device that is separated from a camera.

2. Description of the Related Art

Generally, a camera captures an image of a target subject. Recently, a special camera, namely, an “action camera” capable of capturing dynamic images during extreme activities, such as rafting, mountain bike racing, or the like, has been introduced, and the relevant market is gradually growing.

As the action camera is attached to a user's body or particular possession and captures images by itself, it is not generally equipped with a display device. In some cases, however, a display device is needed, for example, to adjust an angle of the camera or to check an image to be captured. Thus, a display device is separately provided to be optionally attached or detached relative to the action camera.

The aforementioned display device is operable only when mounted on the action camera, and thus it is not possible for a user to adjust an angle of the camera or to check images captured in real time if the action camera is attached to the user's body or possession.

### SUMMARY

The following description relates to a wireless adaptor for operating a display device separated from a camera, the wireless adaptor being water-proof and capable of having the display device mounted therein, allowing a user to check in real time the images captured by the camera.

In one general aspect, there is provided a wireless adaptor for operating a display device that is detachably installed in a camera with a wireless communication function and mounted on the wireless adaptor, the wireless adaptor including: a main body configured to comprise an accommodation area in which the display device is situated and a connector formed on one side of the accommodation area to be electrically connected with the display device; a wireless communication module mounted within the main body to perform wireless communication with the camera; a controller mounted within the main body and configured to comprise a display operating part to receive image data captured and transmitted from the camera through the wireless communication module and output the received image data to the display device; and a battery mounted within the main body to supply power to the controller.

The main body may have a band connecting part on a bottom portion and a band may be engaged to the band connecting part.

The wireless adaptor may further include a cover configured to open or close a top portion of the main body and have a display exposing part at a central portion to expose a touch screen of the display device, wherein either of the cover and the main body has a coupling member to couple the cover to the main body and a first O-ring is mounted on either of contacting surfaces of the cover and the main body.

A second O-ring with a closed curve shape may be mounted along edges of the display exposing part and the display device.

The display exposing part of the cover may have a transparent window through which a touch input is transmitted to the touch screen of the display device.

Other features and aspects will be apparent from the following detailed description, the drawings, and the claims.

### BRIEF DESCRIPTION OF THE DRAWINGS

FIG. 1 and FIG. 2 are perspective views of a wireless adaptor for a display according to an exemplary embodiment.

FIG. 3 is a block diagram illustrating the wireless adaptor of FIG. 1.

FIG. 4 and FIG. 5 are perspective views of a wireless adaptor for a display according to another exemplary embodiment.

FIG. 6 is a side view of the wireless adaptor of FIG. 4 whose cover is open.

FIG. 7 is a longitudinal section view of the wireless adaptor of FIG. 4.

FIG. 8 is a diagram illustrating another example of a display exposing part of the wireless adaptor of FIG. 7.

FIG. 9 is a diagram illustrating another example of a coupling member of the wireless adaptor of FIG. 7.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

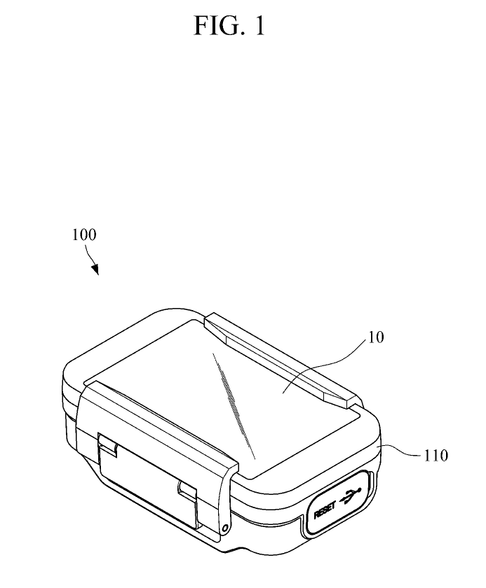

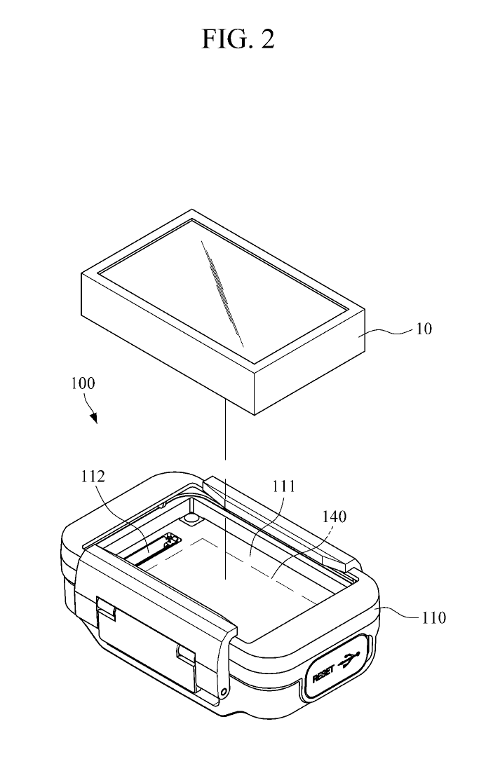

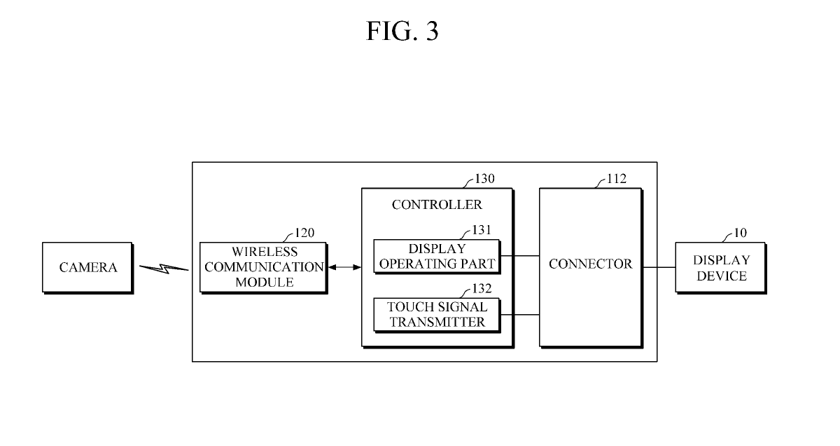

FIG. 1 and FIG. 2 are perspective views of a wireless adaptor for a display according to an exemplary embodiment. FIG. 3 is a block diagram illustrating the wireless adaptor of FIG. 1.

Referring to FIGS. 1 to 3, the wireless adaptor 100 for a display includes a main body 110, a wireless communication module 120, a controller 130, and a battery 140.

The main body 110 includes an accommodation area 111 in which a display device 10 is situated. A connector 112 is formed on one side of the accommodation area 111 to be electrically connected to the display device 10. The display device 10 is detachably installed in a camera equipped with a wireless communication function, and any type of device that is capable of receiving and displaying an image captured by the camera can be used as the display device 10.

The wireless communication module 120 is disposed within the main body 110 and performs wireless communication with the camera. The wireless communication module 120 may be, but not limited to, a WiFi module. The wireless communication module 120 within the main body 110 enables the wireless communication with the camera, so that the display device 10 can be ready to receive image data captured by the camera. Here, the “image” includes “video” and a “still image.”

The controller 130 disposed within the main body 110 includes a display operating part 131 to output image data that have been captured by the camera and received by the wireless communication module 120 to the display device 10. The display operating part 131 is configured to allow the display device 10 to receive the image data captured by the camera, so that the image captured by the camera can be output to the display device 10.

In another aspect, the controller 130 may further include a touch-signal transmitter 132 to drive the camera through the wireless communication module 120 in response to a touch instruction input through a touch screen of the display device 10. That is, as the camera and the display device 10 are connected to each other through the wireless communication module 120, the touch instruction input by a user is allowed to be output to the camera by the touch-signal transmitter 132. Accordingly, the instruction input through the touch screen of the display device 10 may be wirelessly transmitted to the camera to turn the camera on or off.

The battery 140 is mounted within the main body 110 to supply power to the controller 130. Accordingly, the controller 130 can operate without a separate power supply device. In addition, once connected to the connector 112, the display device 10 can also be provided with power from the battery 140, thereby being capable of outputting an image without a separate power supply device.

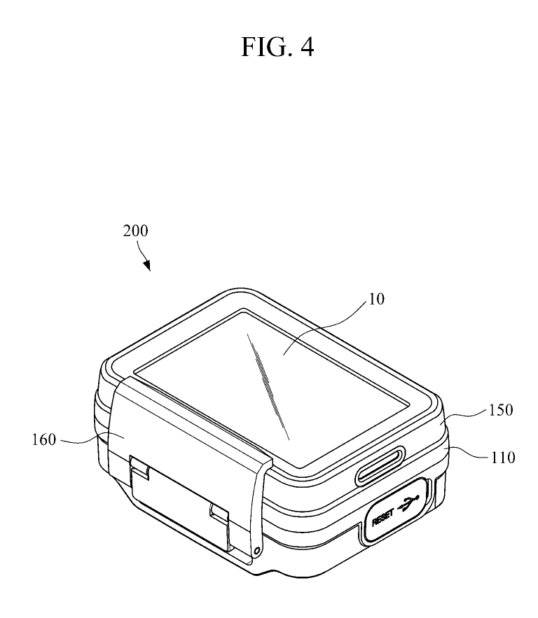

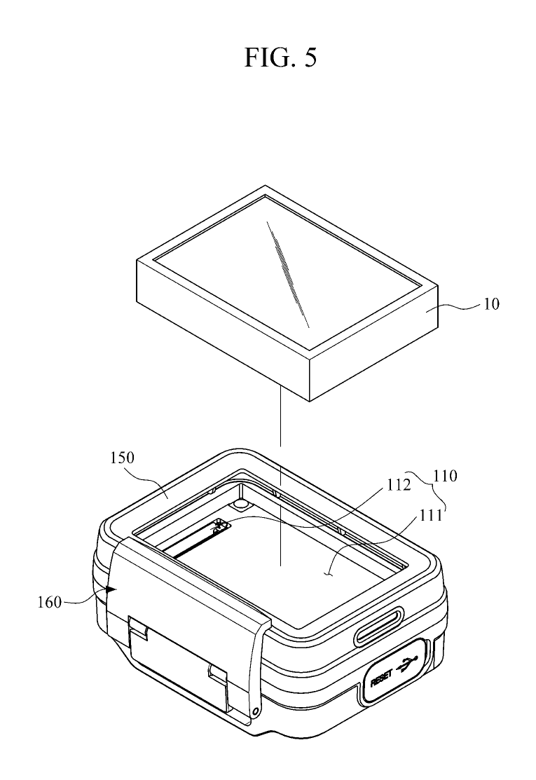

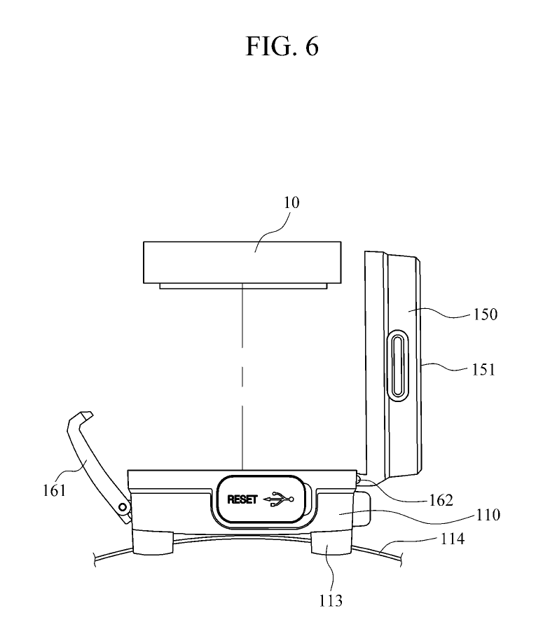

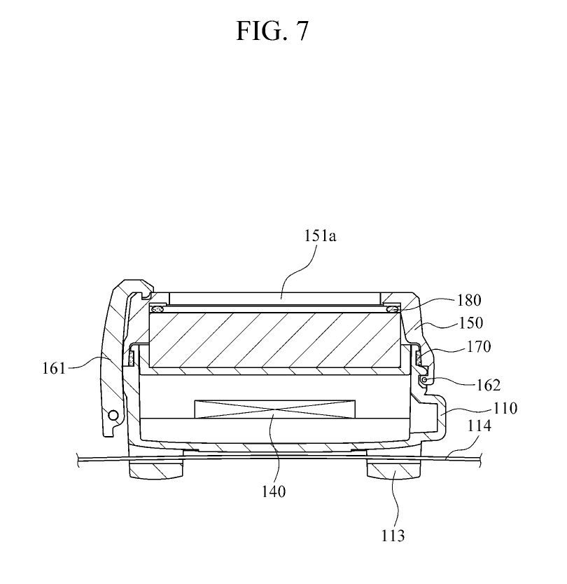

FIG. 4 and FIG. 5 are perspective views of a wireless adaptor for a display according to another exemplary embodiment. FIG. 6 is a side view of the wireless adaptor of FIG. 4 whose cover is opened. FIG. 7 is a longitudinal section view of the wireless adaptor of FIG. 4. Herein, the wireless adaptor for a display shown in FIGS. 4 to 7 will be described, focusing on differences from the wireless adaptor shown in FIGS. 1 to 3.

As shown in FIGS. 4 to 7, the wireless adaptor 200 for a display includes a main body 110 with a band connecting part 113 on the bottom, and a band 114 may be engaged with the band connecting part 113. The band 114 is allowed to be engaged to the bottom of the main body 110, thereby enabling a user to wear the wireless adaptor 200 on a wrist.

As such, since the wireless adaptor 200 for a display is configured to be wearable in wristwatch form, the user is able to check captured images while performing various activities, such as rafting or mountain biking. In addition, since the user can wear the wireless adaptor 200 on a wrist, there is no risk of being lost during vigorous activity.

The wireless adaptor 200 may further include a cover 150 to open or close a top of the main body 110. The cover 150 includes a display exposing part 151 disposed on a central area of the cover 150 through which the touch screen of the display device 10 is exposed. Either of the cover 150 and the main body 110 has a coupling member 160 to allow the cover 150 and the main body 110 to be coupled to each other, and one of contacting surfaces of the cover 150 and the main body 110 may have a first O-ring 170 mounted thereon.

The first O-ring 170 on the contacting surface of either the cover 150 or the main body 110 is provided to hermetically seal a space between the cover 150 and the main body 110 and prevent moisture from seeping into the main body 110, thereby protecting the display device 10 and the connector 112 that is electrically connected with the display device 10.

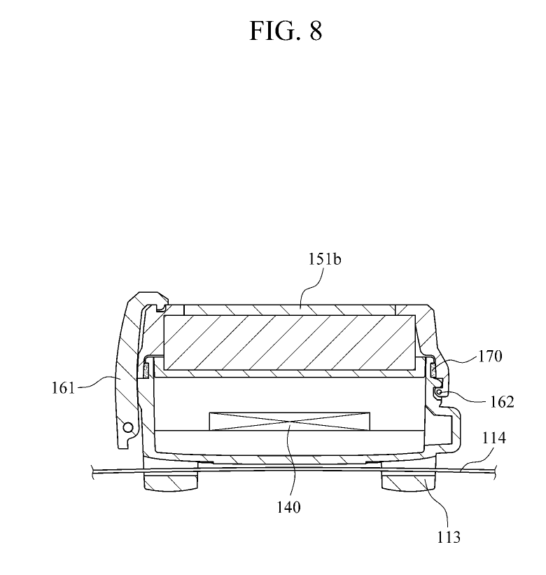

The display exposing part 151 of the cover 150 may be formed as an opening 151a as shown in FIGS. 4 to 7, or formed to have a transparent window 151b as shown in FIG. 8.

In a case where the projection part 151 is formed as the opening 151a, the touch screen of the display device 10 is exposed through the opening 151a, so that a touch input can be received through the touch screen of the display device 10. In this case, moisture may seep into a space between the opening 151a and the display device 10, and thus a second O-ring 180 with a closed curve shape may be mounted along edges of the opening 151a and the display device 10.

The second O-ring 180 mounted on a contacting surface between the projection part 151 and the display device 10 hermetically seals the inside of the wireless adaptor 200, thereby preventing moisture from seeping into the accommodation area 111.

In a case where the projection part 151 includes a transparent window 151b as shown in FIG. 8, the inside of the wireless adaptor 200 is already sealed by the window 151b, and thus there is no need for the second O-ring 180.

The transparent window 151b, if made of general glass or plastic, would not be able to transmit a touch input to the touch screen, so it would be appropriate for the transparent window 151b to be made of a material that can deliver a touch input to the touch screen of the display device 10. An electrostatic or resistive touch input method may be used, but aspects of the present disclosure are not limited thereto and the method may vary depending on user's needs. As well-known technologies, the electrostatic touch input method and the resistive touch input method will not be described in detail.

The coupling member 160 may include a hinge part 162 to rotatably connect the cover 150 with the main body 110, and a locking part 161 to secure the cover to the main body 110. More specifically, the locking part 161 has one end mounted on the main body 110 and the other end with a hook so as to be completely engaged with the cover 150. Then, the cover 150 has a stepped engagement at a position on a surface in contact with the hook, and thus when the hook is inserted into the stepped engagement by pressing the locking part 161, the cover 150 and the main body 110 can be completely engaged with each other so that a space therebetween can be hermetically sealed. In addition, as the cover 150 is rotatably connected with the main body 110 via the hinge part 162, there is no risk of loss of the cover 150.

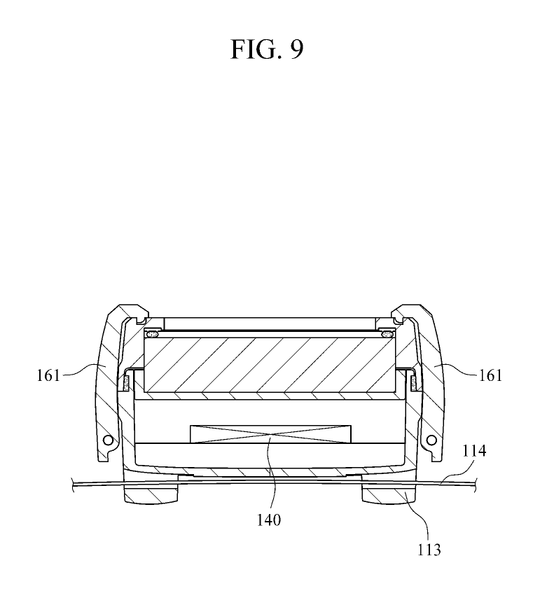

In another example, as shown in FIG. 9, the coupling member 160 may include a pair of locking parts 161 disposed at both sides of the main body 110 to engage the cover 150 to the main body 110. Each of the locking parts 161 has one end mounted on the main body 110, as described above, and the other end with a hook. Also, the cover 150 has stepped engagements on surfaces in contact with each hook. Thus, when the hooks are inserted into the respective stepped engagements by pressing the locking parts 161, the cover 150 and the main body 110 are completely engaged with each other, so that a space therebetween can be hermetically sealed.

As such, by completely sealing the main body 110, the user can use the wireless adaptor 200 safely in any weather conditions, such as snow or rain.

As described above, a display device separated from a camera is operated through a wireless adaptor for the display device so that a user can check captured images in real time. In addition, as the camera and the display device are connected with each other through a wireless communication module and the camera is operated by using a touch signal transmitter on the display device, it is possible to remotely control the camera.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A wireless adaptor for operating a display device that is detachably installed in a camera with a wireless communication function and mounted on the wireless adaptor, the wireless adaptor comprising:
a main body configured to comprise an accommodation area in which the display device is situated and a connector formed on one side of the accommodation area to be electrically connected with the display device;
a wireless communication module mounted within the main body to perform wireless communication with the camera;
a controller mounted within the main body and configured to comprise a display operating part to receive image data captured and transmitted from the camera through the wireless communication module and output the received image data to the display device; and
a battery mounted within the main body to supply power to the controller.

2. The wireless adaptor of claim 1, wherein the main body has a band connecting part on a bottom portion and a band is engaged to the band connecting part.

3. The wireless adaptor of claim 1, further comprising:
a cover configured to open or close a top portion of the main body and have a display exposing part at a central portion to expose a touch screen of the display device,
wherein either of the cover and the main body has a coupling member to couple the cover to the main body and a first O-ring is mounted on either of contacting surfaces of the cover and the main body.

4. The wireless adaptor of claim 3, wherein a second O-ring with a closed curve shape is mounted along edges of the display exposing part and the display device.

5. The wireless adaptor of claim 3, wherein the display exposing part of the cover has a transparent window through which a touch input is transmitted to the touch screen of the display device.

6. The wireless adaptor of claim 3, wherein the coupling member comprises a hinge part to rotatably connect the cover with the main body and a locking part to secure the cover to the main body.

7. The wireless adaptor of claim 3, wherein the coupling member comprises a pair of locking parts disposed at both sides of the main body to secure the cover to the main body.

8. The wireless adaptor of claim 1, wherein the controller comprises a touch signal receiver to drive the camera through the wireless communication module in response to a touch instruction input through a touch screen of the display device.
